(19) United States
(12) Patent Application Publication
(10) Pub. No.: US 2023/0234410 A1
(43) Pub. Date: Jul. 27, 2023

(54) HITCHING APPARATUS AND RELATED METHOD

(71) Applicant: Harrison James Pretlove, Minimay (AU)

(72) Inventor: Harrison James Pretlove, Minimay (AU)

(21) Appl. No.: 18/126,734

(22) Filed: Mar. 27, 2023

Related U.S. Application Data
(63) Continuation of application No. PCT/AU2021/051107, filed on Sep. 22, 2021.

(30) Foreign Application Priority Data
Sep. 28, 2020 (AU) 2020903486

(51) Int. Cl. B60D 1/07; B60D 1/06; B60D 1/02; B60D 1/44

(52) U.S. Cl. CPC B60D 1/07; B60D 1/06; B60D 1/02; B60D 1/44

(57) ABSTRACT

A hitch apparatus is provided for use with a vehicle for providing multiple connector arrangement options. The hitching apparatus may include a body configured for providing first and second arm portions for supporting a respective hitch connector. The body is configured so that each first and second arm portions both extend away from an axis about which the body is selectively rotatable so as to provide a selected hitch connector (ie. selected by way of rotation of the body) in a loading position for connection with a hitch socket provided with a towable platform.

### TECHNICAL FIELD

A hitching apparatus and related methods for its use is disclosed.

### BACKGROUND

A wide variety of connectors exist for connecting a vehicle to be towed, such as a trailer, to a towing vehicle, such as a car, truck or tractor. For example, one popular type of connector is a ball and socket hitch connector. Such ball and socket hitch connectors typically comprise a spherical body or ball connector that is attached to the frame or tow bar of a towing vehicle. The tongue or hitch of the vehicle to be towed is equipped with a socket which is configured to fit over the spherical body or ball connector.

One problem associated with hitch connectors of all types is that the portion of the connector on the towing vehicle is often not compatible with the hitch connector on the vehicle to be towed. This is usually problematic when different types of machinery are used during the course of a day, for example in an agricultural environment. For example, it may be required to change from a ball towing connection to a pin towing connection—which may need to occur multiple times a day. To change a standard towing connection one needs to undo the relevant fastening system (which usually comprises a bottom nut threadedly engaged with a threaded shaft extending from the hitch connector using a shifter or a spanner) and swap between the needed hitch connector(s) (for example, from a ball connector to a pin connector arrangement, or vice-versa). During busy times, for example in the agriculture industry, it is not unusual for this process to be repeated several times a day.

Since many trailers are equipped with a variety of different sized sockets and connectors, it is often necessary to change the portion of the hitch on the towing vehicle to match that on the trailer. Hence, if one has a variety of trailers to be towed, one may have to obtain a large inventory of hitch connectors, and then repeatedly change the connectors in order to accommodate the hitch arrangement on the trailer.

Accordingly, it is posited that there exists a need/market for a solution that seeks to provide a balance to the above considerations. It is therefore against this general background that the embodiments described herein have been developed.

### SUMMARY OF THE INVENTION

According to a first principal aspect, there is provided a hitching apparatus for use with a vehicle for providing multiple connector arrangement towing options, the hitching apparatus comprising:

a body configured for providing first and second portions arranged for supporting a respective connector arrangement,

the first and second portion each being configured so as to be compatible to support different respective connector arrangements, each first and second portion movable so as to be selectively positioned so as to provide a selected one of the portions in a loading position for connection with the respective connector arrangement.

Embodiments of the above described principal aspect, and any of those described below, may comprise or incorporate, either individually or in combination, any of the following features.

The hitching apparatus as exemplified by the principles described herein serve to provide a simple and elegant means of being able to easily switch between alternate hitch connector arrangements (eg. hitch connectors) provided on respective first, second portions without the need to undertake significant modification or dis/assembly of componentry when in the field. In this regard, the hitch connectors connected with respective first and second portions are therefore usually of different specifications so as to be compatible with different types of machinery that may need to be towed by the vehicle.

In an embodiment, each of the first, second portions extend away from the axis about which the body is selectively rotatable such that each of the first, second portions terminates so as to provide a respective distal end being in spaced relation relative to each other.

In an embodiment, the first and second portions are configurable by rotation of the body about an axis.

In an embodiment, the connector arrangement comprises one or more projections spaced apart, the one or more projections configured for receiving a respective one of the first or second portions.

In an embodiment, the one or more projections reduces or prevents rotation of the connector arrangement relative to the respective first, second portion.

In an embodiment, the first and second portions extend away from a region of the body at or near where they meet and about which the body is selectively rotatable.

In an embodiment, a length which the first portion extends is different to a length which the second portion extends.

In an embodiment, said selected connector arrangement is one of the connector arrangements supported by a respective first, second portion.

In an embodiment, the first and second portions extend respectively away from the axis about which the body is selectively rotatable. In another embodiment, the first and second portions extend respectively away from the region of the body at or near where they meet.

In an embodiment, one of the first, second portions is configured having one or more portions thereof arranged so as to be, at least in part, registrable (for example, physically, mechanically, or otherwise) with one or more portions of a connector arrangement in the connection of same with the relevant of the first, second portions.

In an embodiment, each of the first, second portions are provided in the form of respective first, second arm portions.

In an embodiment, the hitching apparatus is part of a hitching system which comprises a coupling assembly which is configured operable for coupling the body with a vehicle such that the body is rotatable relative to the vehicle.

In an embodiment, the at least two projections extend substantially the length of the respective first, second arm portion.

In an embodiment, the connector arrangement can be any type of connector arrangement for coupling with any type of compatible connector arrangement provided with a towable platform, for example, hitch connectors of the spherical or ball, or pin type. Similarly, any compatible connector arrangement is one that is connectable with one of the connector arrangements provided with the hitching apparatus.

In an embodiment, a first type of connector arrangement (for example, a spherical or ball type connector arrangement) is secured with one of the first, second arm portions, and a second type of connector arrangement (for example, a pin type connector arrangement) is secured with the alternate arm portion.

In an embodiment, the connector arrangement comprises a hitch connector. Generally, hitch connectors are fastened to their supporting first or second arm portions by way of a nut being threadedly engaged with a distal end of a threaded shaft which extends from the relevant hitch connector once the threaded shaft has been passed through an appropriately dimensioned aperture formed in the relevant first, second arm portion. Tightening of the nut operates to secure (for example, by clamping) the hitch connector with its supporting first, second arm portion.

In an embodiment, one or more portions of one or both of the first or second arm portions is/are configured so as to be substantially registrable (physically, mechanically, or otherwise) with one or more portions of a body of a hitch connector connected with the relevant of the first or second arm portions for, at least in part, seeking to stabilise (in, for example, one or more degrees of freedom where relative movement or ‘play’ between the registrable components can occur during, for example, a towing operation) the connector for connection purposes, and/or when the hitch connector is in its loading position for connection with a compatible connector arrangement (eg. a hitch socket). Accordingly, in the present context, registration between the relevant of the first, second arm portions and a hitch connector is one which seeks to reduce any relative movement or ‘play’ between both components when undertaking a towing operation. In an embodiment, the geometry of one or both first, second arm portions is informed by the geometry of the body of the relevant hitch connecter so as to enable mutual registration so as to reduce any such movement or

In an embodiment, a substantial portion of the shape of the or each first, second arm portion is configured so as to fit or engage (for example, in a ‘hug’ or ‘snug’ like manner) with one or more portions of a body portion of a hitch connector so as to substantially key both components together for, at least in part, seeking to reduce relative movement or ‘play’ therebetween during, for example, a towing operation.

In an embodiment, one or both of the first, second arm portions is configured so as to provide one or more portions thereof that is/are shaped substantially complementary with a respective portion of a body of a hitch connector so that the hitch connector and the relevant of the first, second arm portions are able to substantially register (physically, mechanically, or otherwise) with each other in a manner that operates to confer sufficient stability to the formed connection. In this manner, mutual registration between the relevant of the first, second arm portions and the body of the hitch connector seeks to reduce any relative movement therebetween during, for example, a towing operation. Such registration is advantageous when the hitch connector is in the loading position so as to provide a generally safe and structurally reliable connection during a towing operation.

In an embodiment, one or both of the first, second arm portions are shaped so as to comprise one or more portions (for example, surface or edge portions) thereof which are substantially registrable with respective portions (for example, surface or edge portions) of a body of a hitch connector to be connected with the relevant first, second arm portions, such registration between the or each portion of the first, second arm portion and the body of the hitch connector comprising or involving a substantial abutment of the relevant portions involved in the registration.

In an embodiment, the registration between the relevant of the first, second arm portions and the body of the hitch connector is one providing, or enabling a convergence toward, a substantial ‘snug’ or ‘hug’ like fit/registration therebetween.

In an embodiment, the portion(s) of the first, second arm portions which register with respective/corresponding portion(s) of the body of the hitch connector are shaped substantially complementary with those of said body with which they register (or abut) so as to enable the ‘snug’ or ‘hug’ like fit/registration.

In an embodiment, one or more portions of opposite edges of one or both first, second arm portions are configured so that the relevant of the first, second arm portion is receivable between spaced apart projections extending from the body of the hitch connector, the shape of said one or more respective portions of said opposite edges of the relevant first, second arm portion being configured in a manner that is substantially complementary with corresponding edge portions of respective said spaced projections so as to enable a ‘snug’ fit where, for example, opposing portions of the opposite edges of the relevant of the first, second arm portions and the spaced projections are arrangeable in an abutting-like relationship for reducing relative movement or ‘play’ between the relevant of the first, second arm portion and the body of the hitch connector. As noted, the design/configuration of any portion of said opposite edges of the relevant first, second arm portion is informed by the configuration of the spaced projections so as to enable an appropriate mutual registration between the relevant arm portion and the body of the hitch connector.

In an embodiment, the coupling assembly comprises first and second parts arranged in spaced relation by way of a third part at or near an end thereof.

In an embodiment, the third part is configured at or near a first end for carrying the first and second parts in spaced relation and, at or near a second of the third part, for releasably coupling with the vehicle.

In an embodiment, the body is configured having a first aperture formed therein and arranged so as to be substantially concentric with the axis about which the body rotates.

In an embodiment, each of the first and second parts of the coupling assembly comprise first respective apertures arranged in a substantially concentric manner. In this manner, coupling of the body with the coupling assembly is enabled by way of a shaft or pin being inserted through a passage formed by the concentric alignment of said first respective apertures of the first, second parts of the coupling assembly and the first aperture of the body when the body is intermediate said first, second parts, and the shaft or pin being sufficiently secured so as to remain in position in the passage. In an embodiment, the shaft or pin is provided by way of a shaft portion of a bolt of a nut-bolt fastening system.

In an embodiment, the body comprises reinforcement provided at or adjacent said portion of the body about which the body rotates. In an embodiment, said reinforcement is provided in the form of a tubular portion extending from one side of the body and substantially concentric with the axis about which the body selectively rotates.

In an embodiment, the tubular portion is welded to said one side of the body so as to be substantially concentric with the first aperture.

In an embodiment, the spacing between the first and second parts is arranged so that a portion of the body and the tubular portion can be received or accommodated therebetween.

In an embodiment, the first aperture and a passage of the tubular portion are configured so as to receive a shaft or pin portion that is releasably securable so as to reside in position within the aperture/passage (for example, for the purposes of establishing the rotatable coupling between the body and the coupling assembly). In an embodiment, the shaft or pin portion is provided in the form of a fastener, such as for example, a bolt, and which is operably completed by way of an appropriate nut. In an embodiment, the shaft or pin is provided in fixed relation relative to the first, second parts of the coupling assembly so as to reside in position within the first aperture and said passage of the tubular portion, the shaft or pin serving as a hinge arrangement for enabling rotation of the body.

In an embodiment, each of the first and second arm portions comprise respective edges which meet at or near the axis about which the body rotates.

In an embodiment, said edges of respective first and second arm portions are substantially linear at or near where they meet.

In an embodiment, said edges of respective first and second arm portions are substantially orthogonal each other. The cross-sectional or geometrical form of each of said edges may be substantially uniform along their respective lengths.

In an embodiment, each of the first and second arm portions are configured at or near respective distal ends for connection with a respective hitch connector. In this manner, the first and second arm portions serve to carry or support a respective hitch connector.

In an embodiment, hitch connectors connected with respective first and second arm portions are different.

In an embodiment, the hitch apparatus comprises a retaining arrangement configured operable for confirming the first or second arm portions in their respective loading position once selected. In an embodiment, the retaining arrangement is operable with the body for confirming a loading position. For example, in an embodiment, retention of the first, second arm portion in their respective loading position is via one or more apertures formed within the body and configured for receiving a retaining pin or shaft therethrough such that the pin/shaft also interacts with a component of or associated with the vehicle, wherein the interaction/engagement of the pin/shaft with the body and said component cooperate to hold the first, second arm portion, whichever is selected, in their respective loading position. In an embodiment, the body is formed with an aperture associated with each of the first, second arm portions for use in confirming either in their respective loading position by way of the pin/shaft and its interaction/engagement with the body and said component.

In a further embodiment, the retaining arrangement is operable with the body and one or more portions of the coupling assembly. For example, in one form, retention of the first, second arm portions in their respective loading position is via an aperture formed within the body and in one or both of the first and second parts of the coupling assembly such that concentric alignment of the relevant apertures define a passage through which the retaining pin/shaft can be received and operable for retaining the relevant of the first, second arm portion in its loading position.

In an embodiment, each of first, second parts of the coupling assembly are formed with (i) a first set of one or more apertures which align concentrically in a substantially concentric manner (eg. at least one of said first set of apertures formed in the first part aligns concentrically with at least one of said first set of apertures formed in the second part) so that when aligned substantially concentrically with an aperture formed in the body (the alignment resulting from appropriate selective rotation/pivoting of the body about the axis) define a first passage for receiving the pin/shaft for operable use in confirming a loading position of one of the first, second arm portions, and (ii) a second set of one or more apertures which align concentrically in a substantially concentric manner (eg. at least one of said second set of apertures formed in the first part aligns concentrically with at least one of said second set of apertures formed in the second part) so that when aligned substantially concentrically with a further aperture formed in the body (the alignment resulting from appropriate selective rotation/pivoting of the body about the axis) define a second passage for receiving the pin/shaft for operable use in confirming a loading position of the alternate of the first, second arm portions.

In an embodiment, one or more of the first and second sets of apertures of respective first, second parts are positioned in respect of their respective first, second parts so as to be spaced from or about the axis about which the body rotates.

In an embodiment, one or more of the first and second sets of apertures of respective first, second parts are positioned in respect of their respective first, second parts so as to be substantially concentric with the axis about which the body rotates.

In an embodiment, one or more of the first and second sets of apertures of respective first, second parts are aligned such that their respective centres are collinear.

In an embodiment, one or more of the first and second sets of apertures of respective first, second parts, and or respective first apertures of the first second parts, are aligned such that their respective centres are collinear.

In an embodiment, a line in respect of which one or more of the first, second sets of apertures is positioned is spaced from an edge of their respective first, second parts.

In an embodiment, one or more of the first and second sets of apertures of respective first, second parts are spaced further from said edge than the first apertures of respective first, second parts. In another form, one or more of the first and second sets of apertures of respective first, second parts are spaced:

(i) further from the said edge than the first apertures of respective first, second parts, and or

(ii) adjacent or within close proximity to the first apertures of respective first, second parts.

In this manner, a closer relative grouping of the respective first, second sets of apertures relative the axis about which the body rotates can be achieved so as to allow the profile of the first and or second parts to be shaped or configured (eg. using rounded or chamfered defining edges defining the profile) so as to allow for a wider range of connector arrangements to be connected with respective first, second arm portions so as to enjoy additional clearance (eg. from the first, second parts of the coupling assembly) when being rotated in/out of loading positions.

In an embodiment, each of the first and second parts of the coupling assembly comprise one or more further respective apertures arranged so that one or more of said further apertures of the first and second parts align in a substantially concentric manner for receiving a shaft or pin therethrough for use in confirming a fixed relative position between the body and the coupling assembly when a respective first or second arm portion is in a respective loading position. In this manner, fixing or retaining of the body relative to the coupling assembly is enabled by way of the shaft or pin being inserted through a passage formed by the concentric alignment of the relevant further apertures of respective first, second parts of the coupling assembly and at least one second aperture formed within the body, and the shaft or pin being sufficiently secured so as to remain in position in the passage. The position of the or each second aperture of the body relative to the relevant of the further respective apertures of the first, second parts is arranged so as to provide either of the first, second arm portions in its loading position (depending on which of the first, second arms is selected). In an embodiment, the shaft or pin is provided by way of a shaft portion of a bolt of a nut-bolt fastening system.

In an embodiment, the first and second parts of the coupling assembly comprise second and third respective apertures registrable with respective second and third apertures provided in the body, whereby,

(i) confirmation of the loading position of the first arm portion is enabled by a shaft or pin being passed through a passage defined by the concentric alignment of the second apertures of respective first, second parts of the coupling assembly, and the second aperture of the body, and the shaft or pin being sufficiently secured so as to remain in position in said passage, and

(ii) confirmation of the loading position of the second arm portion is enabled by a shaft or pin being passed through a passage defined by the concentric alignment of the third apertures of respective first, second parts of the coupling assembly and the third aperture of the body, and the shaft or pin being sufficiently secured so as to remain in position in said passage.

In an embodiment, respective first apertures of the first, second parts of the coupling assembly are provided intermediate the second and third respective apertures.

In an embodiment, one or more of the second and third apertures of respective first, second parts are positioned on their respective first, second parts so as to be spaced from or about the axis about which the body rotates.

In an embodiment, one or more of the second and third apertures of respective first, second parts are positioned on their respective first, second parts so as to be substantially concentric with the axis about which the body rotates.

In an embodiment, one or more of the second and third apertures of respective first, second parts are aligned such that their respective centres are collinear relative to each on their respective first, second part.

In an embodiment, one or more of the second and third apertures of respective first, second parts, and or respective first apertures of the first second parts, are aligned such that their respective centres are collinear relative to each on their respective first, second part.

In an embodiment, a line on which one or more of the second, third apertures is positioned is spaced from an edge of their respective first, second parts.

In an embodiment, one or more of the second, third apertures of respective first, second parts are spaced further from said edge than the first apertures of respective first, second parts. In another embodiment, one or more of the second, third apertures of respective first, second parts are spaced:

(i) further from the said edge than the first apertures of respective first, second parts, and or

(ii) adjacent or within close proximity to the first apertures of respective first, second parts.

As noted, such a configuration seeks to allow for a wider range of connector arrangements to be connected with respective first, second arm portions so as to enjoy additional clearance when rotated in/out of loading positions.

In confirming the loading position of the first, second arm portions, the relevant fastening system is operated to a secured condition.

In an embodiment, the body is configured so that hitch connectors carried by respective first and second arm portions are projected at different lengths from the axis about which the body rotates.

In an embodiment, the third part may be coupled with the vehicle by way of being received within a port carried by the vehicle. For example, said port comprises a portion of rectangular tube-like form capable of receiving a portion of the second end of the third part. In an embodiment, for example, the said port carried by the vehicle is the standard 50 mm type.

In an embodiment, the third part is a section or length of a rectangular tube.

In an embodiment, the third part is configured so that it can be releasably secured with the tubular port at more than one relative position. In this manner, the distance that the hitching apparatus is projected from the vehicle can be changed or selected as required by selectively adjusting the relative position of the third part relative to the tubular port carried by the vehicle.

In an embodiment, each of the relative positions between the third part and the tubular port are confirmed by way of a shaft or pin being inserted through apertures formed in each of the tubular port and the third part when aligned in a substantially concentric manner, and said shaft or pin releasably secured in position.

In an embodiment, the third part is configured so that it can be releasably secured with the tubular port at a plurality of relative positions. In the preferred embodiment, the third part is configured so that it can be releasably secured with the tubular port at two relative positions.

In an embodiment, respective lengths of the first and second arm portions are different.

In an embodiment, the body is rotatable through an angle of about 90 degrees.

In an embodiment, an angle between the directions of the respective lengths (or the directions in which the respective lengths extend) of the first and second arm portions is about 90 degrees.

In an embodiment, the body comprises a portion which extends between the first and second arm portions. In an embodiment, said portion extending between the first and second arm portions also extends substantially toward the distal ends of one or both of the first, second arm portions. In this manner, said portion operates a web for conferring structural reinforcement between the first, second arm portions. It will be appreciated that the shape or configuration of said portion can vary based on structural considerations as required.

According to a second principal aspect, there is provided a hitching apparatus for use with a vehicle for providing multiple connector arrangement towing options, the hitching apparatus comprising:

a body configured for providing first and second portions arranged for supporting a respective connector arrangement,

each first and second portion movable so as to be selectively positioned so as to provide a selected one of the portions in a loading position for connection with the respective connector arrangement,

wherein one of the first, second portions is configured having one or more elements thereof arranged so as to be, at least in part, registrable with one or more sections of the respective connector arrangement on the connection of the one or more sections with the relevant one of the first, second portions for reducing relative movement therebetween.

In an embodiment, each element comprises a part of an edge of the respective first or second portion.

In an embodiment, each section comprises one or more projections.

In an embodiment, the first and second portions are configurable by rotation of the body about an axis.

In an embodiment, the first and second portions extend away from the axis a different length relative to each other.

In an embodiment, the hitching apparatus further comprises a coupling assembly configured for rotatably coupling the body with the vehicle.

In an embodiment, the coupling assembly comprises a first and second part in a spaced arrangement for receiving the body therebetween.

In an embodiment, the body is rotatably coupled to the coupling assembly by way of a hinge arrangement.

In an embodiment, the coupling assembly comprises a third part extending longitudinally and configured to be coupled to a vehicle.

In an embodiment, the third part receives or is received by a hitch receiver of the vehicle.

In an embodiment, the body is configurable such that the respective first or second portion which is not in the loading position can be moved from a first position to a second position which is opposite the first position.

In an embodiment, the first or second portion is in the loading position when a longitudinal axis of the respective first or second portion is substantially aligned or parallel with a longitudinal axis of the vehicle.

In an embodiment, the first or second portion is in the loading position when a longitudinal axis of the respective first or second portion is substantially orthogonal with a longitudinal axis of the vehicle.

In an embodiment, a second compatible connector arrangement is coupled to the respective first or second portion not in the loading position.

In an embodiment, the body is releasably fixed relative to the coupling assembly by removably inserting a retaining member in a passage defined by alignment of an aperture of the body with one or more apertures of the coupling assembly.

According to a third principal aspect, there is provided a hitching apparatus for use with a vehicle for providing multiple connector arrangement towing options, the hitching apparatus comprising:

a body configured for providing first and second portions arranged for supporting a respective connector arrangement,

each first and second portion extending away from an axis about which the body is selectively rotatable so as to provide a selected connector arrangement in a loading position for connection with a compatible connector arrangement,

a coupling assembly configured for rotatably coupling the body with the vehicle.

According to a fourth principal aspect, there is provided a hitching apparatus for use with a vehicle for providing multiple connector arrangement towing options, the hitching apparatus comprising:

a body configured for providing first and second portions arranged for supporting a respective connector arrangement,

each first and second portion extending away from an axis about which the body is selectively rotatable so as to provide a selected connector arrangement in a loading position for connection with a compatible connector arrangement,

one of the first, second portions is configured having one or more portions thereof arranged so as to be, at least in part, registrable with one or more portions of a connector arrangement on the connection of same with the relevant of the first, second portions for reducing relative movement therebetween, and

a coupling assembly configured for rotatably coupling the body with the vehicle.

In an embodiment, the coupling assembly of the third or fourth principal aspects comprises any embodiment of the coupling assembly of the first or second principal aspects, or as otherwise described herein.

According to a fifth principal aspect, there is provided a method for forming a hitching apparatus or system for use with a vehicle for providing multiple connector arrangement towing options, the method comprising:

providing, forming or operably configuring a body for providing first and second portions for supporting a respective connector arrangement, the first and second portion each being configured so as to be compatible to support different respective connector arrangements, each first and second portion movable so as to be selectively positioned so as to provide a selected one of the portions in a loading position for connection with the respective connector arrangement.

According to a sixth principal aspect, there is provided a method for forming a hitching apparatus or system for use with a vehicle for providing multiple connector arrangement towing options, the method comprising:

providing, forming or operably configuring a body for providing first and second portions for supporting a respective connector arrangement, each first and second portion movable so as to be selectively positioned so as to provide a selected one of the portions in a loading position for connection with the respective connector arrangement,

providing, forming or operably configuring one of the first, second portions so as to have one or more elements thereof arranged so as to be, at least in part, registrable with one or more sections of the respective connector arrangement on the connection of the one or more sections with the relevant one of the first, second portions for reducing relative movement therebetween.

In an embodiment, the method further comprises providing, forming or operably configuring a coupling assembly for rotatably coupling the body with the vehicle.

According to a seventh principal aspect, there is provided a method for forming a hitching apparatus or system for use with a vehicle for providing multiple connector arrangement towing options, the method comprising:

providing, forming or operably configuring a body for providing first and second portions for supporting a respective connector arrangement, each first and second portion extending away from an axis about which the body is selectively rotatable so as to provide a selected connector arrangement in a loading position for connection with a compatible connector arrangement, and

providing, forming or operably configuring a coupling assembly for rotatably coupling the body with the vehicle.

According to an eighth principal aspect, there is provided a method for coupling a towable platform to a vehicle, the method comprising:

associating a coupling assembly with the vehicle;

providing, forming or operably configuring the coupling assembly for rotatable coupling with the body;

moving a body to provide a selected one of a first or second portion of the body in a loading position relative to the coupling assembly for connection with a respective connector arrangement;

fixing the position of the body relative to the coupling assembly;

connecting the respective connector arrangement to the respective one of the first or second portion of the body in the loading position; and

coupling the towable platform to the respective connector arrangement.

In an embodiment, the method of the present principal aspect comprises rotating the body so as to position or provide a selected connector arrangement in its loading position for connecting with a compatible connector arrangement of or provided with the towable platform.

According to a ninth principal aspect, there is provided a kit of parts comprising:

a body configured for providing first and second portions arranged for supporting a respective connector arrangement, the first and second portion each being configured so as to be compatible to support different respective connector arrangement, each first and second portion movable so as to be selectively positioned so as to provide a selected one of the portions in a loading position for connection with the respective connector arrangement, and

a coupling assembly configured for rotatably coupling the body with a moveable platform.

According to a tenth principal aspect, there is provided a kit of parts comprising:

a body configured for providing first and second portions arranged for supporting a respective connector arrangement,

each first and second portion movable so as to be selectively positioned so as to provide a selected one of the portions in a loading position for connection with the respective connector arrangement,

wherein one of the first, second portions is configured having one or more elements thereof arranged so as to be, at least in part, registrable with one or more sections of the respective connector arrangement on the connection of the one or more sections with the relevant one of the first, second portions for reducing relative movement therebetween; and

a coupling assembly configured for rotatably coupling the body with a moveable platform.

In an embodiment, the body is configured in accordance with any embodiment of the body of the hitching apparatus described herein.

In an embodiment, the kit comprises a coupling assembly configured for rotatably coupling the body with the vehicle. In an embodiment, the coupling assembly is provided in the form of any embodiment of the coupling assembly described in relation to the first principal aspect, or as otherwise described herein.

According to a further principal aspect, there is provided a hitching apparatus for use with a vehicle for providing multiple connector arrangement towing options, the hitching apparatus comprising:

a body configured for providing first and second portions arranged for supporting a respective connector arrangement,

each first and second portion extending away from a region of the body at or near where they meet and about which the body is selectively rotatable so as to provide a selected connector arrangement in a loading position for connection with a compatible connector arrangement.

According to another principal aspect, there is provided a hitching apparatus for use with a vehicle for providing multiple connector arrangement towing options, the hitching apparatus comprising:

a body configured for providing first and second portions arranged for supporting a respective connector arrangement,

each first and second portion extending away from a region of the body at or near where they meet and about which the body is selectively rotatable so as to provide a selected connector arrangement in a loading position for connection with a compatible connector arrangement,

one of the first, second portions configured having one or more portions thereof arranged so as to be, at least in part, registrable with one or more portions of a connector arrangement on the connection of same with the relevant of the first, second portions for reducing relative movement therebetween.

According to another principal aspect, there is provided a hitching apparatus for use with a vehicle for providing multiple connector arrangement towing options, the hitching apparatus comprising:

a body configured for providing first and second portions arranged for supporting a respective connector arrangement,

each first and second portion extending away from an axis about which the body is selectively rotatable so as to provide a selected connector arrangement in a loading position for connection with a compatible connector arrangement, and

a retaining arrangement configured operable with the body for confirming the first or second portion in a respective loading position.

According to a further principal aspect, there is provided a hitching apparatus for use with a vehicle for providing multiple connector arrangement towing options, the hitching apparatus comprising:

a body configured for providing first and second portions arranged for supporting a respective connector arrangement,

each first and second portion extending away from an axis about which the body is selectively rotatable so as to provide a selected connector arrangement in a loading position for connection with a compatible connector arrangement,

one of the first, second portions configured having one or more portions thereof arranged so as to be, at least in part, registrable with one or more portions of a connector arrangement on the connection of same with the relevant of the first, second portions for reducing relative movement therebetween, and

a retaining arrangement configured operable with the body for confirming the first or second portion in a respective loading position.

According to another principal aspect, there is provided a hitching apparatus for use with a vehicle for providing multiple connector arrangement towing options, the hitching system comprising:

a body configured for providing first and second portions arranged for supporting a respective connector arrangement,

each first and second portion extending away from an axis about which the body is selectively rotatable so as to provide a selected connector arrangement in a loading position for connection with a compatible connector arrangement,

a coupling assembly configured for rotatably coupling the body with the vehicle, and

a retaining arrangement configured operable with the body and the coupling assembly for confirming the first or second portion in a respective loading position.

According to a further principal aspect, there is provided a hitching apparatus for use with a vehicle for providing multiple connector arrangement towing options, the hitching system comprising:

a body configured for providing first and second portions arranged for supporting a respective connector arrangement,

each first and second portion extending away from an axis about which the body is selectively rotatable so as to provide a selected connector arrangement in a loading position for connection with a compatible connector arrangement,

one of the first, second portions configured having one or more portions thereof arranged so as to be, at least in part, registrable with one or more portions of a connector arrangement on the connection of same with the relevant of the first, second portions for reducing relative movement therebetween,

a coupling assembly configured for rotatably coupling the body with the vehicle, and

a retaining arrangement configured operable with the body and the coupling assembly for confirming the first or second portion in a respective loading position.

In further aspects, embodiments of the hitching apparatus as described herein are exemplified in the form of corresponding hitching systems.

Various principal aspects described herein can be practiced alone or combination with one or more of the other principal aspects, as will be readily appreciated by those skilled in the relevant art. The various principal aspects can optionally be provided in combination with one or more of the optional features described in relation to the other principal aspects. Furthermore, optional features described in relation to one example (or embodiment) can optionally be combined alone or together with other features in different examples or embodiments.

For the purposes of summarising the principal aspects, certain aspects, advantages and novel features have been described herein above. It is to be understood, however, that not necessarily all such advantages may be achieved in accordance with any particular embodiment or carried out in a manner that achieves or optimises one advantage or group of advantages as taught herein without necessarily achieving other advantages as may be taught or suggested herein.

It is to be understood that each document, reference, patent application or patent cited in this text is expressly incorporated herein in their entirety by reference, which means that it should be read and considered by the reader as part of this text. That the document, reference, patent application, or patent cited in this text is not repeated herein is merely for reasons of conciseness.

Furthermore, in this specification, where a literary work, act or item of knowledge (or combinations thereof), is discussed, such reference is not an acknowledgment or admission that any of the information referred to formed part of the common general knowledge as at the priority date of the application. Such information is included only for the purposes of providing context for facilitating an understanding of the inventive concept/principles and the various forms or embodiments in which those inventive concept/principles is/are exemplified.

### BRIEF DESCRIPTION OF THE DRAWINGS

Further features of the inventive principles are more fully described in the following description of several non-limiting embodiments thereof. This description is included solely for the purposes of exemplifying the inventive principles. It should not be understood as a restriction on the broad summary, disclosure or description as set out above. The description will be made with reference to the accompanying drawings in which:

FIG. 1 shows a perspective view of an embodiment of a hitching apparatus arranged in accordance with the principles described herein (with hitch connector arrangement(s) omitted);

FIG. 2 shows a further perspective view of the embodiment shown in FIG. 1 (with hitch connector arrangement(s) omitted);

FIG. 3 shows a perspective view of an embodiment of a body of the hitching apparatus shown in FIG. 1;

FIG. 4 shows an exploded perspective view of the body shown in FIG. 3, and the embodiment of a coupling assembly shown in FIG. 1;

FIG. 5 shows a further perspective view of the embodiment shown in FIG. 1 (showing a loading position with hitch connector arrangement omitted);

FIG. 6 shows another perspective view of the embodiment shown in FIG. 1 (showing a loading position with hitch connector arrangement omitted);

FIG. 7 shows a perspective view of the embodiment shown in FIG. 1 with two types of connecting arrangements (ball hitch type connector, pin type connector) attached to respective first, second portions (arm portions);

FIG. 8 shows a perspective view showing registration between a pin type hitching connector arrangement and the embodiment of the hitching apparatus shown in FIG. 1 (from underneath looking upwards);

FIG. 9 shows a further perspective view showing registration between a pin type hitching connector arrangement and the embodiment of the hitching apparatus shown in FIG. 1 (bottom view looking upwards);

FIG. 10 shows a perspective view of another embodiment of a hitching apparatus arranged in accordance with the principles described herein (with hitch connector arrangement(s) omitted);

FIG. 11 shows a further perspective view of the embodiment shown in FIG. 10 (with hitch connector arrangement(s) omitted);

FIG. 12 shows a perspective view of an embodiment of a body of the hitching apparatus shown in FIG. 10;

FIG. 13 shows an exploded perspective view of the body shown in FIG. 12, and the embodiment of a coupling assembly shown in FIG. 10;

FIG. 14 shows a further perspective view of the embodiment shown in FIG. 10 (showing a loading position with hitch connector arrangement omitted);

FIG. 15 shows another perspective view of the embodiment shown in FIG. 10 (showing a loading position with hitch connector arrangement omitted);

FIG. 16 shows a perspective view of the embodiment shown in FIG. 10 with two types of connecting arrangements (ball hitch type connector in a loading position, and pin type connector) attached to respective first, second portions (arm portions);

FIG. 17 shows a side view of an alternative embodiment of the hitching apparatus having the body secured by the coupling assembly; and

FIG. 18 shows an isometric view of the hitching apparatus of FIG. 17.

In the figures, like elements are referred to by like numerals throughout the views provided. The skilled reader will appreciate that elements in the figures are illustrated for simplicity and clarity and have not necessarily been drawn to scale. For example, the dimensions and/or relative positioning of some of the elements in the figures may be exaggerated relative to other elements to facilitate an understanding of the various embodiments exemplifying the principles described herein. Also, common but well understood elements that are useful or necessary in a commercially feasible embodiment are often not depicted in order to provide a less obstructed view of these various embodiments. It will also be understood that the terms and expressions used herein adopt the ordinary meaning as is accorded to such terms and expressions with respect to their corresponding respective areas of inquiry and study except where specific meanings have otherwise been set forth herein.

It should be noted that the figures are schematic only and the location and disposition of the components can vary according to the particular arrangements of the embodiment(s) as well as of the particular applications of such embodiment(s).

Specifically, reference to positional descriptions, such as ‘lower’ and ‘upper’, and associated forms such as ‘uppermost’ and ‘lowermost’, are to be taken in context of the embodiments shown in the figures, and are not to be taken as limiting the scope of the principles described herein to the literal interpretation of the term, but rather as would be understood by the skilled reader.

Embodiments described herein may include one or more range of values (eg. size, displacement and field strength etc). A range of values will be understood to include all values within the range, including the values defining the range, and values adjacent to the range which lead to the same or substantially the same outcome as the values immediately adjacent to that value which defines the boundary to the range.

Other definitions for selected terms used herein may be found within the detailed description and apply throughout. Unless otherwise defined, all other scientific and technical terms used herein have the same meaning as commonly understood to one of ordinary skill in the art to which the embodiment(s) relate.

### DETAILED DESCRIPTION

The words used in the specification are words of description rather than limitation, and it is to be understood that various changes may be made without departing from the spirit and scope of any aspect of the invention. Those skilled in the art will readily appreciate that a wide variety of modifications, alterations, and combinations can be made with respect to the above described embodiments without departing from the spirit and scope of any aspect of the invention, and that such modifications, alterations, and combinations are to be viewed as falling within the ambit of the inventive concept.

Throughout the specification and the claims that follow, unless the context requires otherwise, the word “comprise” or variations such as “comprises” or “comprising”, will be understood to imply the inclusion of a stated integer or group of integers but not the exclusion of any other integer or group of integers.

Furthermore, throughout the specification and the claims that follow, unless the context requires otherwise, the word “include” or variations such as “includes” or “including”, will be understood to imply the inclusion of a stated integer or group of integers but not the exclusion of any other integer or group of integers.

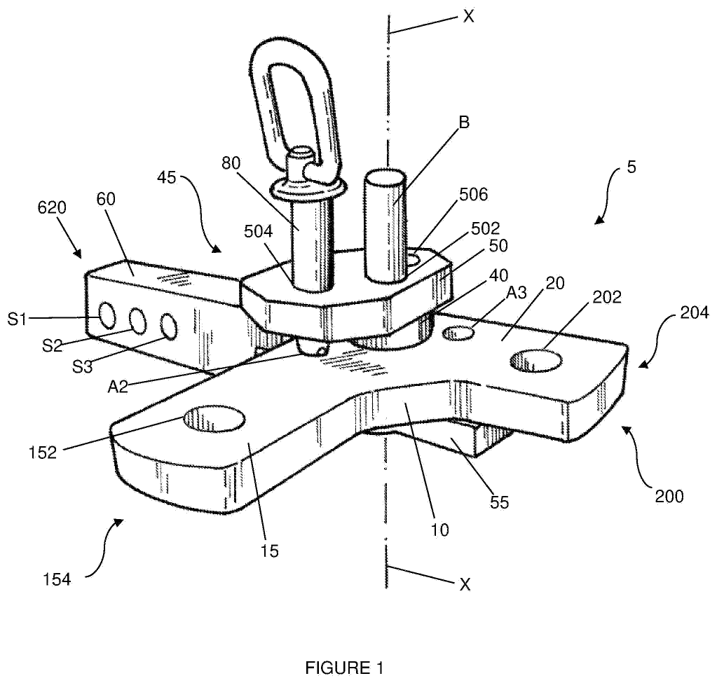

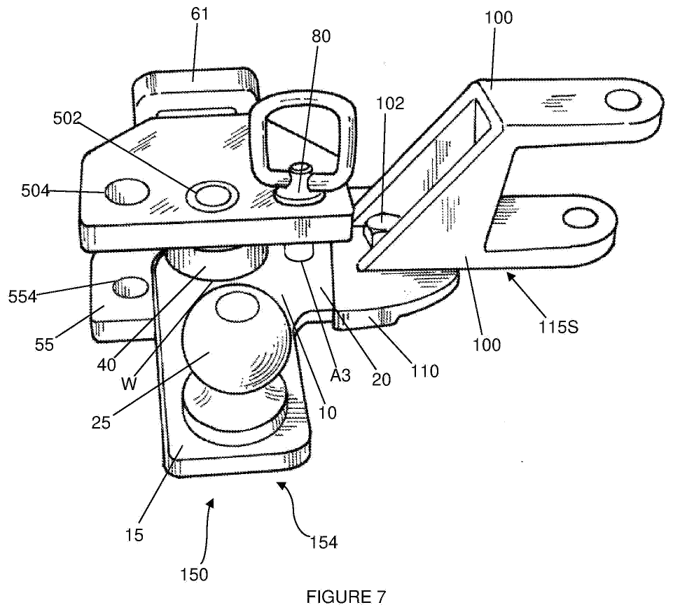

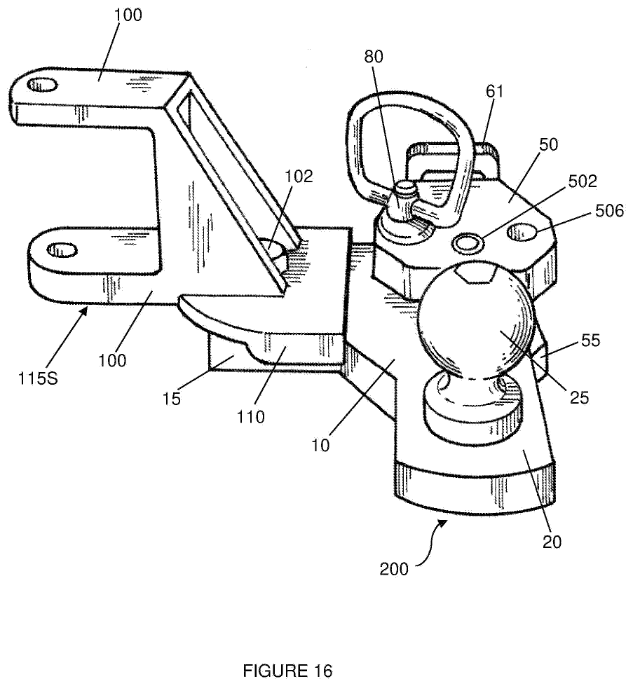

FIGS. 1 to 9 show an embodiment a hitching apparatus 5 for use with a vehicle for providing multiple connector arrangement options for towing purposes. In the form shown, the hitching apparatus 5 comprises a body 10 configured for providing first 15 and second 20 arm portions for supporting a respective connector arrangement provided in the form of hitch connectors—which could be of any known type, such as for example, spherical or ball type hitch connectors 25 (for example, a spherical or ball type hitch connector 25 shown in FIGS. 7 and 16), or pin type hitch connectors (for example, a pin type connector 100 also shown in FIGS. 7 and 16). The body 10 is configured so that each first 15 and second 20 arm portions both extend away from an axis X about which the body 10 is selectively rotatable so as to provide a selected hitch connector 25, 100, by way of rotation or pivoting of the body 10 about the axis X, to a respective loading position 150, 200 (see FIGS. 1, 2, 5, 6, and 7) for connection with a compatible hitch connector (for example, a hitch socket) provided with a towable platform (not shown). Put another way, the first 15 and second 20 arm portions extend away from a region of the body 10 at or near where they meet and about which the body 10 is selectively rotatable (eg. the axis X).

The hitching apparatus 5 as exemplified by the principles described herein serves to provide a simple and elegant means of being able to easily switch between alternate hitch connectors (provided on respective first 15, second 20 arm portions) without the need to undertake significant modification or dis/assembly of componentry when in the field. In one form of use, the hitch connectors connected with respective first 15 and second 20 arm portions are usually of different type or specification so as to be compatible with different machinery that may need to be towed by the vehicle during a working session (for example during the course of a working day).

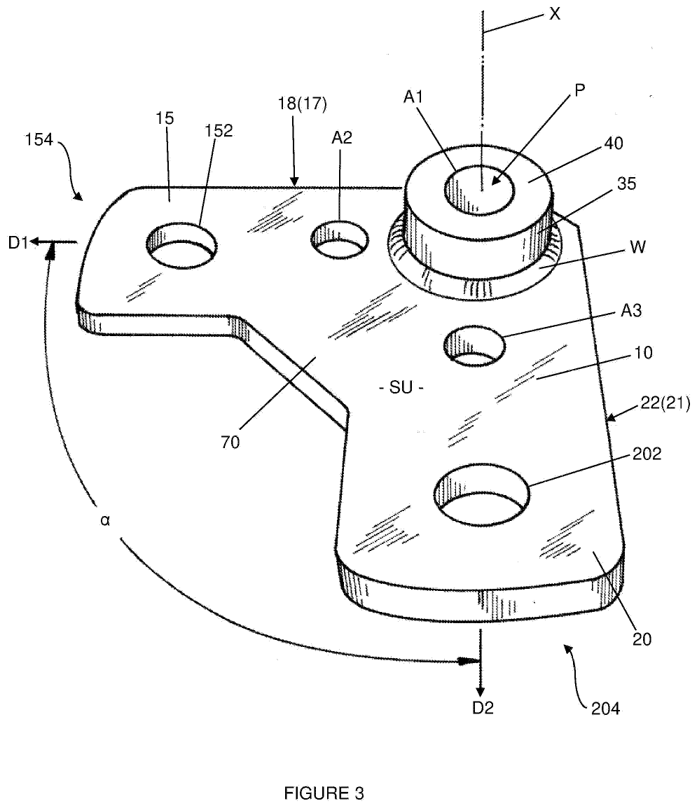

With reference to FIG. 3, the body 10 is formed so that each of the first 15 and second 20 arm portions extend away from the axis X in an elongate manner providing generally spaced apart and parallel edges or sides (of a generally rectangular cross-sectional form along its extension), and terminate so as to define respective distal ends 154, 204. As clearly shown in the Figures, there may be an angle of approximately 90 degrees between the directions D1, D2 of the respective lengths of extension of the first 15 and second 20 arm portions.

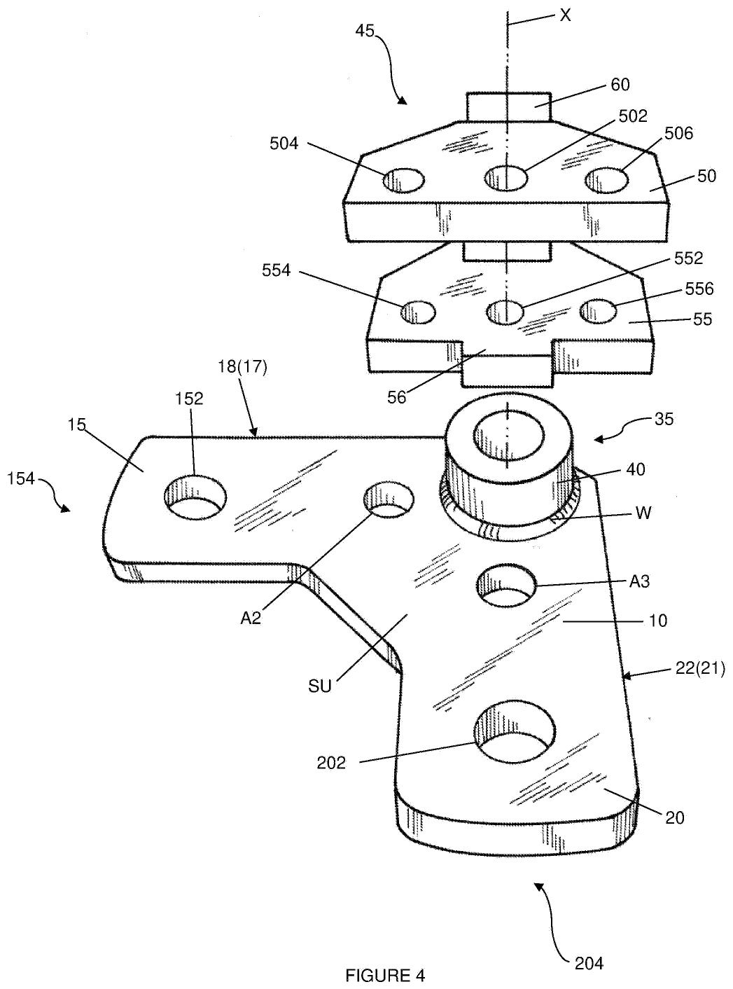

Each of the first 15 and second 20 arm portions are configured near respective distal ends 154, 204 for connection with respective hitch connectors (which may or may not be of the same specification), so as to support respective hitch connectors distal of the axis X (so as to allow for convenient connection with a compatible hitch connector provided with a towable platform). Respective hitch connectors are connected with respective first 15 and second 20 arm portions by way of respective apertures 152, 202 being formed therein near their respective distal ends 154, 204 allowing threaded shaft portions of each hitch connector to be passed through the appropriate apertures 152, 202 so as to be engageable with respective nuts on the opposite side of the relevant arm portion 15, 20. As seen from FIG. 4, apertures 152, 202 are spaced from each at about 90 degrees with respect to the axis X. The skilled reader will appreciate that other means of securing the hitch connectors with respective first 15, second 20 arm portions will be possible for providing a releasable securement or otherwise.

With reference to FIG. 3, the body 10 comprises a first aperture A1 (obscured from view due to the tubular portion 40, described below) formed therein and arranged so as to be substantially concentric with the axis X, and used to accommodate a shaft or pin portion used in enabling the rotatable movement of the body 10. The body 10 further comprises reinforcement 35 provided adjacent to the periphery of the aperture A1. The reinforcement 35 is provided in the form of a tubular portion 40 extending from an upper facing side SU of the body 10 and aligned substantially concentric with the axis X. In the form shown, the tubular portion 40 is welded (see weld W in at least FIG. 3) to the side SU of the body 10 for assisting in conferring sufficient structural support to the body when operable between first 50 and second 55 parts of a coupling assembly 45 (see FIG. 4) when subject to loading due to connection with a compatible hitch socket (or connector arrangement) during a towing operation. In another embodiment, tubular portion 40 may be separate from body 10. For example, tubular portion 40 may comprise a washer (not shown). The first aperture A1 and a passage P of the tubular portion 40 are substantially concentric with each other so as to receive a shaft or pin B that is appropriately secured (with the coupling assembly 45) so as to reside in position within the aperture/passage, and which shaft or pin B is used for enabling rotatable/pivotable coupling of the body 10 with the coupling assembly 45 (which serves to rotatably couple the body 10 with a vehicle (described below)).

The body further comprises second A2 and third A3 apertures formed therein (as shown in FIG. 4), each aperture being provided so as to be associated with respective first 15, second 20 arm portions. Each of the apertures A2, A3 are used for confirming the first 15, second 20 arm portions in respective loading positions 150, 200 as will be described below. As seen from FIG. 4, apertures A2, A3 are spaced from each other at about 90 degrees with respective to the axis X.

With reference to FIG. 3, side portions 17, 21 (of the first 15, second 20 arm portions respectively) comprise respective edges 18, 22 which meet near the axis X. The meeting edges 18, 22 of the first 15 and second 20 arm portions are substantially linear along their respective lengths (each being aligned substantially parallel with respective directions D1, D2), are each substantially of uniform form along their respective lengths (eg. having a square edge) and are arranged substantially orthogonal with each other where they meet.

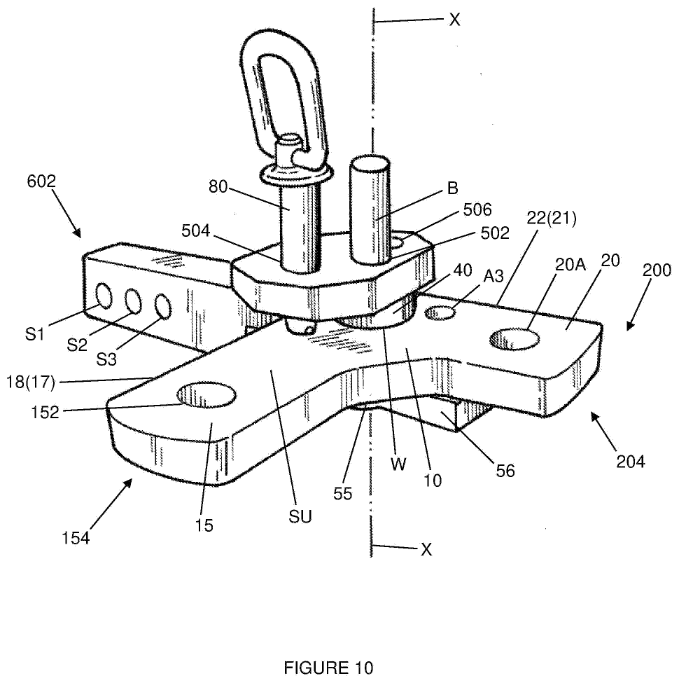

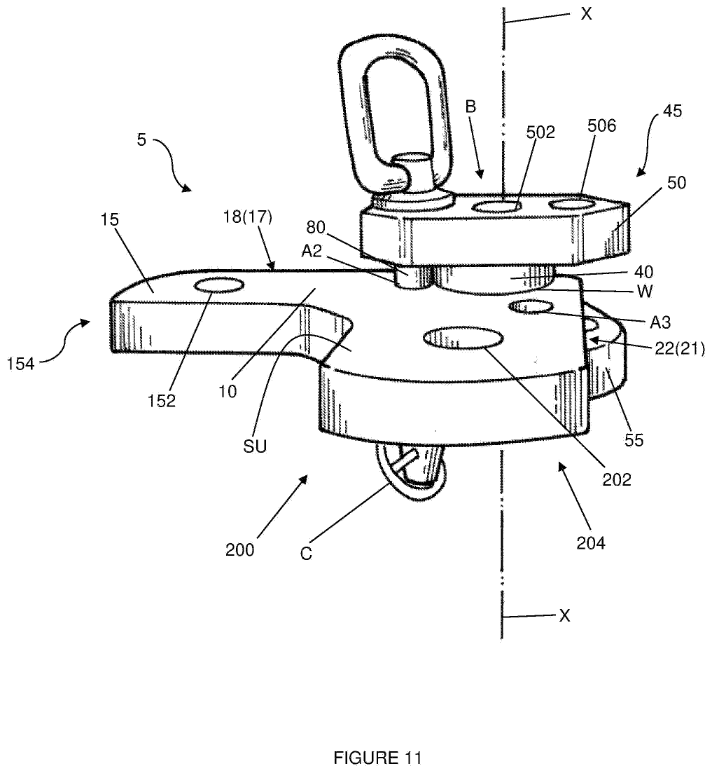

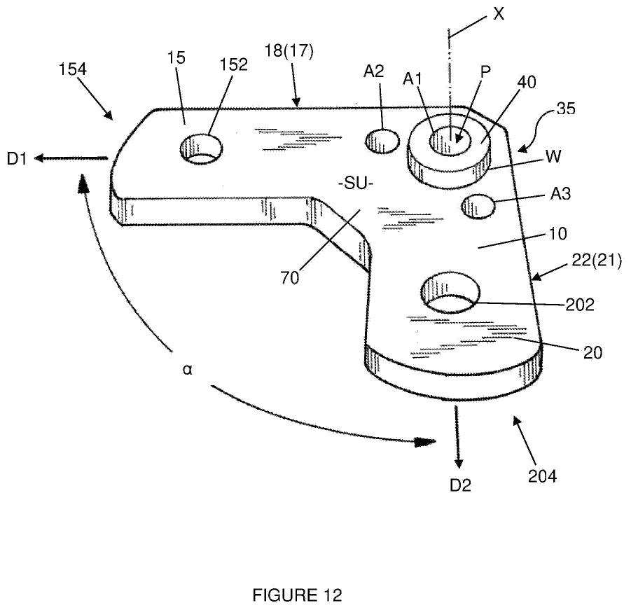

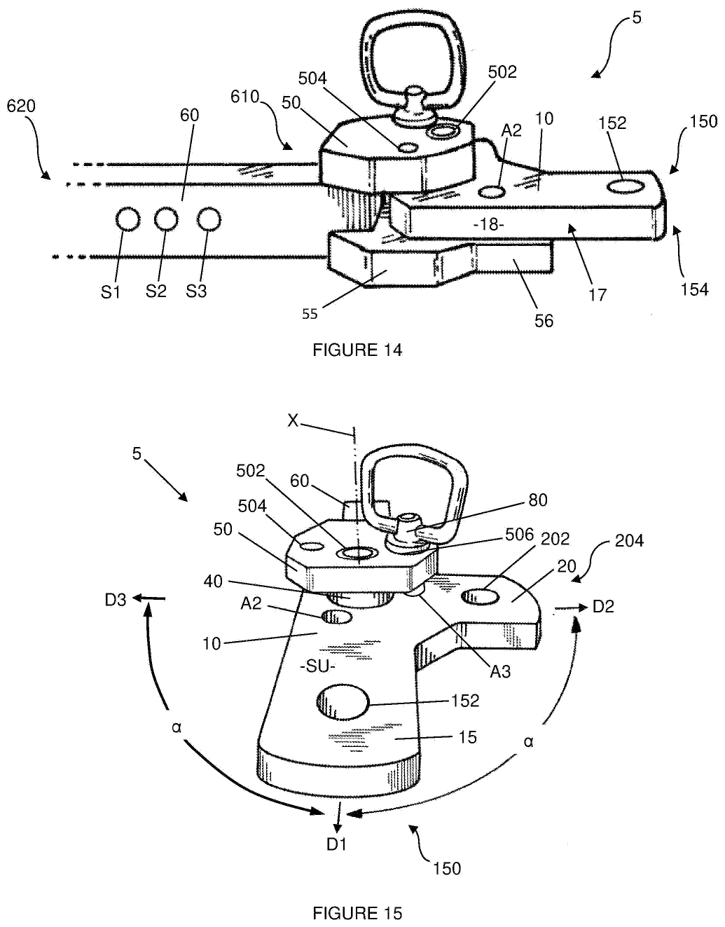

The body 10 comprises a reinforcing portion 70 which extends between the first 15 and second 20 arm portions, as shown in FIG. 3. The reinforcing portion 70 is configured of web-like form extending between the first 15 and second 20 arm portions while also extending substantially toward their respective distal ends 154, 204. In this manner, the reinforcing portion 70 operates as a structural ‘web’ for conferring structural reinforcement between the first 15, second 20 arm portions. It will be appreciated that the shape or configuration of the reinforcing portion 70 can vary based on structural considerations as required. In the embodiment of the hitching apparatus 5 shown in FIGS. 1 to 9, each of the distal ends 154, 204 are substantially square shaped (with roundings provided on corner regions), whereas the analogous features shown in the embodiment the subject of FIGS. 10 to 16 are non-linear, or exhibit a substantially rounded form. The skilled reader will appreciate that the shape/configuration of the distal ends 154, 204 could be of any form as might be required for a given application/circumstance.

Different configurations of the respective lengths of the first 15 and second 20 arm portions can be realised so as to alter the projected distance of a respective supported hitch connector from the axis X. In an embodiment, the distance from a distal end (154, 204) of each first 15 and second 20 arm portion that a respective hitch connector is fixed at can be the same. In such an arrangement, the lengths of the relevant first 15, second 20 arm portions can be changed so as to change the projected distance of the hitch connector from the axis X. For the embodiment shown in the Figures, the respective lengths of the first 15 and second 20 arm portions are substantially the same and the position at which the respective hitch connector is connected along the length of the relevant arm portion is substantially the same. However, with reference to FIGS. 10 to 16, embodiments drawing from the principles described herein can be realised in which the lengths of the first 15, second 20 arm portions are different.

In another form, the respective lengths of the first 15 and second 20 arm portions are substantially the same, and the position at which the respective hitch connector is connected along the length of the relevant arm portion, can be varied as needed.

It will be appreciated that the apertures 152, 202 formed in respective first 15 and second 20 arm portions used to fasten a respective hitch connector thereto could be shaped so as to allow the distance between the axis X and the fastened hitch connector to be variable as needed. For example, one or both apertures 152, 202 formed in respective first 15 and second 20 arm portions could be of elongated form allowing the threaded shaft extending from the respective hitch connector to be translatable along the length of the elongation. The skilled reader would appreciate that other arrangements could be possible in varying the projected distance of a respective supported hitch connector from the axis X.

### Coupling Assembly

With reference to FIG. 1, the hitching apparatus 5 is operable with a coupling assembly 45 configured for coupling the body 10 with a vehicle so that the body is (selectively) rotatable/pivotable relative to the vehicle and the coupling assembly 45. The coupling between the coupling assembly 45 and the body 10 is configured so that the body 10 is selectively rotatable through an angle of about 90 degrees about the axis X by way of bolt B serving as a point of rotation or pivot.

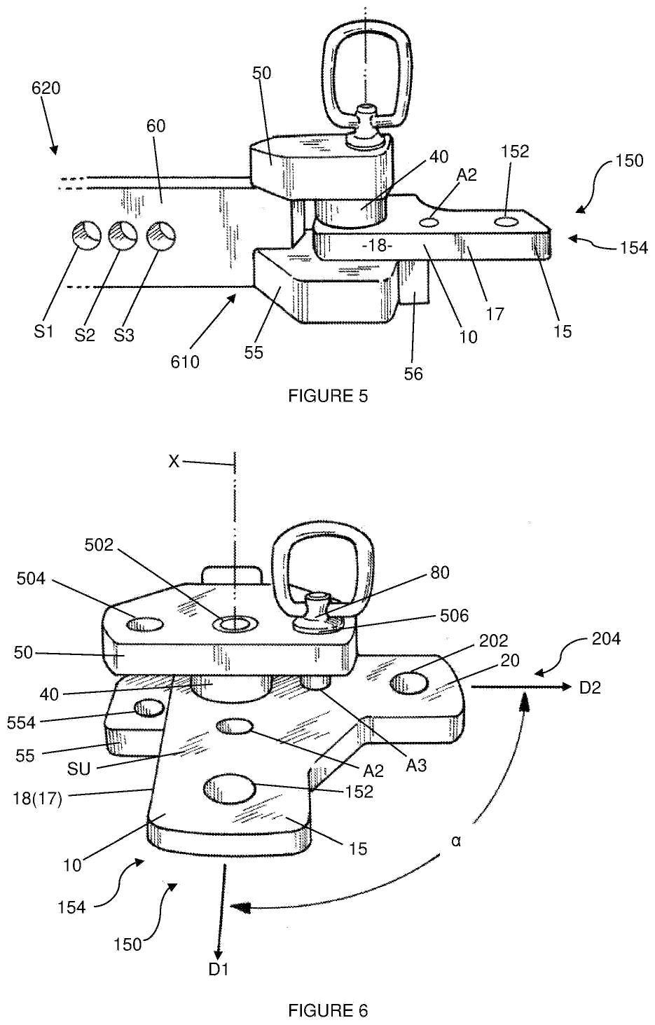

The coupling assembly 45 comprises first 50 and second 55 parts arranged and held (by way of a suitable welding process) in spaced relation relative to each other by way of a third part 60, as readily shown in FIGS. 4 and 5. The third part 60 is configured at or near a first end 610610 thereof for carrying the first 50 and second 55 parts in their spaced relationship and, at or near a second 620 (of the third part 60) for coupling with the vehicle (for example, within a tubular port 61 (shown in FIG. 7) supported by the vehicle's chassis at its rearward end).

The spacing between the first 50 and second 55 parts is arranged so that a portion of the body 10 and the tubular portion 40 can be received or accommodated therebetween. It will be appreciated that the spacing between the first 50 and second 55 parts can be sized so as to reduce (or increase) the amount of ‘play’ provided to the body/tubular portions. It is, however, preferable, for the available ‘play’ to be minimised so as to allow scope for some support to be conferred to the body 10 when accepting load from a hitch socket connected to one of the hitch connectors (25, 100, as shown in FIG. 7), while allowing the body to be rotatable for allowing selection of a desired hitch connector carried thereby.

With reference to FIG. 5, the third 60 and second 55 parts are assembled together so that their respective lowermost facing surfaces are substantially aligned or ‘flush’ relative to each other. Such arrangement serves to assist to reduce or prevent ‘drag’ (or contact with the ground) when towing through steep drains.

The rearward extending dimension (that which is aligned substantially with the longitudinal—or forward, rearward—axis of the vehicle) of the second part 55 of the coupling assembly 45 is sized so as to extend or project further rearward than the first part 50 in order to provide additional structural support to the body 10 when receiving loading from a connected hitch socket. In increasing the rearward extending dimension of the second part 55, the lengths of the first 15 and second 20 arm portions of the body 10 can also be increased to assist in increasing towing options. Furthermore, for the embodiment shown in the Figures, the second part 55 is provided with extending portion 56 (shown in FIG. 4 and FIG. 5) which extends/projects rearward outward from the second part so as to provide additional support for the body 10 when under load (ie. supporting load when carried by either of the first 15, second 20 arms when their respective hitch connectors are connected to compatible connectors of equipment to be towed). The extending portion 56 can be shaped/configured in any manner required for structural purposes. For example, the extending portion 56 extends further outward (rearward) from the second part 55 in the embodiment of the hitching apparatus 5 the subject of the FIGS. 10 to 16 in order to augment the support conferrable to the body 10.

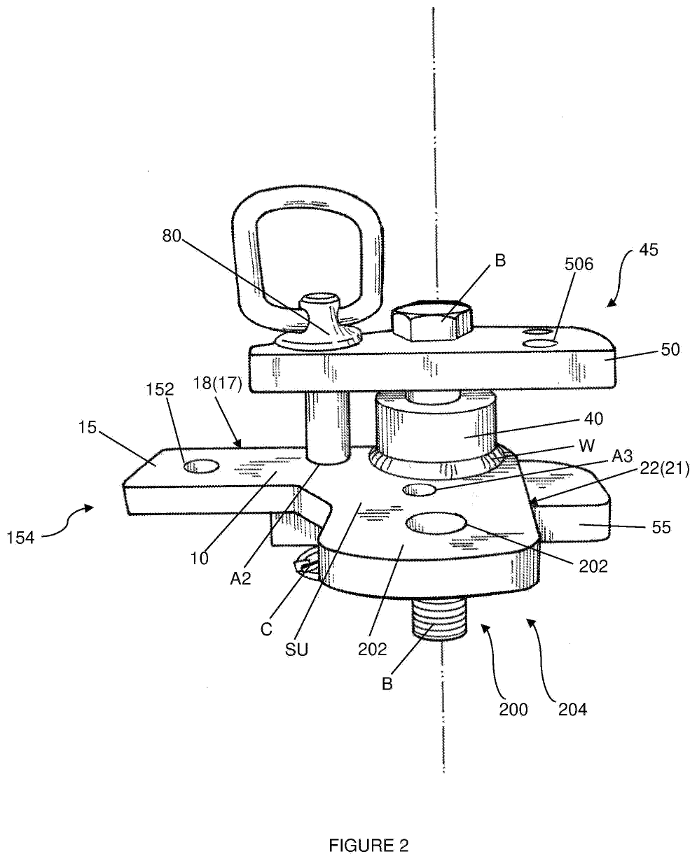

With reference to FIG. 4, each of the first 50 and second 55 parts of the coupling assembly 45 comprise respective generally centrally located first apertures 502, 552 arranged in a substantially concentric manner relative to each other. Rotatable coupling of the body 10 with the coupling assembly 45 is enabled by way of a shaft or pin B (see FIGS. 1 and 2) being inserted through (so as to reside therein) a passage formed by the concentric alignment of the respective first apertures 502, 552 of the first 50, second 55 parts of the coupling assembly 45, and the aperture A1 of the body 10 when the body is positioned intermediate said first 50, second 55 parts. Once the shaft or pin B resides in the passage, it is sufficiently secured (eg. being welded in position) to adjacent portions of the first 50, second 55 parts so as to remain in position. In this manner, the shaft or pin B serves as a fixed pivot point (substantially concentric with axis X) about which the body 10 is selectively rotatable/pivotable so that either of the first 15 or second 20 arm portions can be provided in their respective loading positions 150, 200 as required.

In an embodiment, the shaft or pin B is of solid steel and its length modified so as to be flush with the lower facing surface of the second part 55 so as to mitigate against any prospective contact with the ground (eg. when going through steep drain's (while camping or farming)).

The hitch apparatus 5 comprises a retaining arrangement configured operable for confirming the first 15 or second 20 arm portions in their respective loading position 150, 200. In the embodiment shown in the Figures and described herein, the retaining arrangement involves use of a retaining pin or shaft 80 that is operable with the body 10 and the first 50, second 55 parts of the coupling assembly 45. Broadly, each of the first 50, second 55 parts of the coupling assembly 45 are formed with (i) a first set of one or more apertures which align substantially concentrically across the first 50, second 55 parts, and which, when aligned substantially concentrically with an aperture formed in the body 10 (the alignment resulting from appropriate selective rotation/pivoting of the body about the axis X) operate to define a first passage for receiving the pin/shaft 80 for operable use in confirming a loading position of one of the first 15, second arm 20 portions, and (ii) a second set of one or more apertures which align substantially concentrically across the first 50, second 55 parts, and which, when aligned substantially concentrically with a further aperture formed in the body 10 (the alignment resulting from appropriate selective rotation/pivoting of the body about the axis X), define a second passage for receiving the pin/shaft 80 for operable use in confirming a loading position of the alternate of the first 15, second 20 arm portions.

With reference to FIG. 4, each of the first 50 and second 55 parts of the coupling assembly 45 comprise a plurality of apertures arranged so as to provide a pair of corresponding apertures that are in spaced relationship with one another (for example, one aperture being formed within the first part 50, and the other of the pair being formed within the second part 55), each pair arranged so that each of the apertures align in a substantially concentric manner relative to each other. Each pair of apertures is operable for defining a passage for receiving the retaining shaft or pin 80 therein for confirming a fixed relative position between the body 10 and the coupling assembly 45 (and, indeed, the vehicle) when a respective first 15 or second 20 arm portion is in its respective loading position 150, 200. For the embodiment shown, the first 50 part of the coupling assembly 45 comprises further apertures 504 and 506 (each spaced either side of the first aperture 502 formed in the first part 50) which correspond with, and register concentrically with, further apertures 554 and 556 (each spaced either side of the first aperture 552 formed in the second part 55) formed in the second 55 part of the coupling assembly 45. In this manner, a first pair of apertures comprises apertures 504 and 554, and a second pair of apertures comprises apertures 506 and 556.

Restraint of the body 10 relative to the coupling assembly 45 (and the vehicle) is enabled by way of the shaft or pin 80 being inserted through a passage formed by the concentric alignment of the relevant of the apertures 504, 506, 554 and 556 of respective first 50, second 55 parts of the coupling assembly 45 with the relevant of the apertures A2, A3 of the body 10, and the shaft or pin 80 being sufficiently secured in the relevant defined passage using clip C (see FIG. 2) so as to remain in position in the passage. The position of the apertures A2, A3 of the body 10 relative to the relevant corresponding apertures 50/554, 50/556 of respective first 50, second 55 parts is arranged so as to releasably secure either of the first 15, second 20 arm portions in its respective loading position 150, 200 (depending on which loading position of the first 15, second 20 arm portions is selected). The skilled reader would appreciate that the shaft or pin may be provided by way of a shaft portion of a bolt of a nut-bolt fastening system.

Thus, respective corresponding apertures (i.e., aperture 504 corresponding with aperture 554, and aperture 506 corresponding with aperture 556) of respective first 50 and second 55 parts of the coupling assembly 45 are registrable with respective second A2 and third A3 apertures provided in the body 10, for allowing:

(i) confirmation/securement of a loading position 150 of the first arm portion 15 by way of the shaft/pin 80 being passed through a passage defined by the concentric alignment of the respective apertures 506, 556 of the first 50, second 55 parts and the aperture A3 of the body 10 (FIGS. 5 and 6 show the loading position 150 in which a hitch connector connected with the second arm portion 15 is available for use with a compatible hitch socket); and

(ii) confirmation/securement of a loading position 200 of the second arm portion 20 by way of the shaft/pin 80 being passed through a passage defined by the concentric alignment of the respective apertures 504, 554 of the first 50, second 55 parts and the aperture A2 of the body 10 (FIGS. 1 and 2 show the loading position 200 in which a hitch connector connected with the second arm portion 20 is available for use with a compatible hitch socket).

Using the retaining arrangement described herein, the body 10 can be readily rotated/pivoted and securely retained in position as needed in order to provide a hitch connector carried by the first 15, second 20 arm portions in a respective loading position 150, 200 ready for use.

In each case, the shaft/pin 80 can be sufficiently secured (for example, using a clip (C) or nut when a bolt is used) so as to remain in position in the relevant defined passage. As will be appreciated, other securing mechanisms may be provided to prevent rotation of the body 10 relative to the coupling assembly 45 when confirmation of a loading position is required. For example, other such securing mechanisms may include a clamp, a latch, and the like to prevent such rotation.

As will be seen from FIG. 4, the apertures 502/552 of respective first 50, second 55 parts of the coupling assembly 45 are provided intermediate respective second 504/554 and third 506/556 apertures. Furthermore, the apertures 502/552 and the second 504/554 and third 506/556 apertures are aligned so as to be substantially collinear with each other, whereby the line in respect of which they are collinear is spaced from the (rearmost facing) edges of respective parts 50, 55 as shown in FIG. 4.

It will be appreciated that retention of the first 15, second 20 arm portions in their respective loading positions 150, 200 could be configured such that the pin/shaft 80 is passed through the relevant aperture A2, A3 formed in the body 10 and inserted therein sufficiently so as to interact or engage with a separate component that is part of or associated with the vehicle and configured of a form so as to operate with the pin/shaft 80 in retaining the selected of the first 15, second 20 arm portion in their respective loading position.

In some embodiments, in order to provide extra towing options, the concentrically aligned apertures (504, 506, 554, 556) provided in respective first 50 and second 55 parts of the coupling assembly 45 can be brought in so as to be closer the axis X, or spaced further from their respective surrounding adjacent edges (of their respective host bodies) a few millimetres (depending on manufacturing tolerances). As such, and depending on the spacing used, the first part 50 can be made smaller and/or its peripheral edges shaped (eg. rounded or chamfered as appropriate) so as to create additional space for different towing options to swing past.

As shown in FIG. 1 and FIG. 5, the third part 60 of the coupling assembly 45 is provided in the form of an elongated section of rectangular tube and sized so as to be received within the tubular port 61 usually carried by the chassis of the vehicle. For example, in one form, the tubular port 61 usually comprises a portion of rectangular tube configured capable of receiving a portion of length extending from the second end 620 of the third part 60. In one form, for example, the tubular port carried by the vehicle is the standard 50 mm type.

The third part 60 of the coupling assembly 45 is further configured so that it can be releasably secured in position with the tubular port 61 at more than one relative positions. In this manner, the distance that the hitching apparatus 5 is projected from the rear end of the vehicle can be changed or selected as required. To enable this variation in projected length from the vehicle, the third part 60 is provided with a plurality of pairs of apertures S1, S2, S3 (each pair being concentrically aligned) where components of each pair are formed in opposite vertically aligned side walls of its tubular section. Each pair of apertures are spaced from each other along a longitudinal axis of the vehicle (running forward to rear of the vehicle). In this manner, each pair of oppositely disposed and concentrically aligned apertures S1, S2, S3 correspond to a relative position between the third part 60 and the tubular port 61, which, in turn, corresponds to a projected distance of the hitch apparatus 5 rearward from the vehicle. Confirmation of a desired projection of the hitch apparatus 5 from the vehicle is enabled by way of a pin (or similar) being inserted through a selected pair of the apertures S1, S2, S3 and one or more concentrically aligned apertures formed in the vertically aligned and opposing side walls of the tubular port 61, and releasably secured in position (for safety purposes, for example). As is clear from that shown in FIG. 5, the third part 60 is configured so that it can be releasably secured with the tubular port 61 so as to project the hitching apparatus 5 rearward of the vehicle at three different distances.

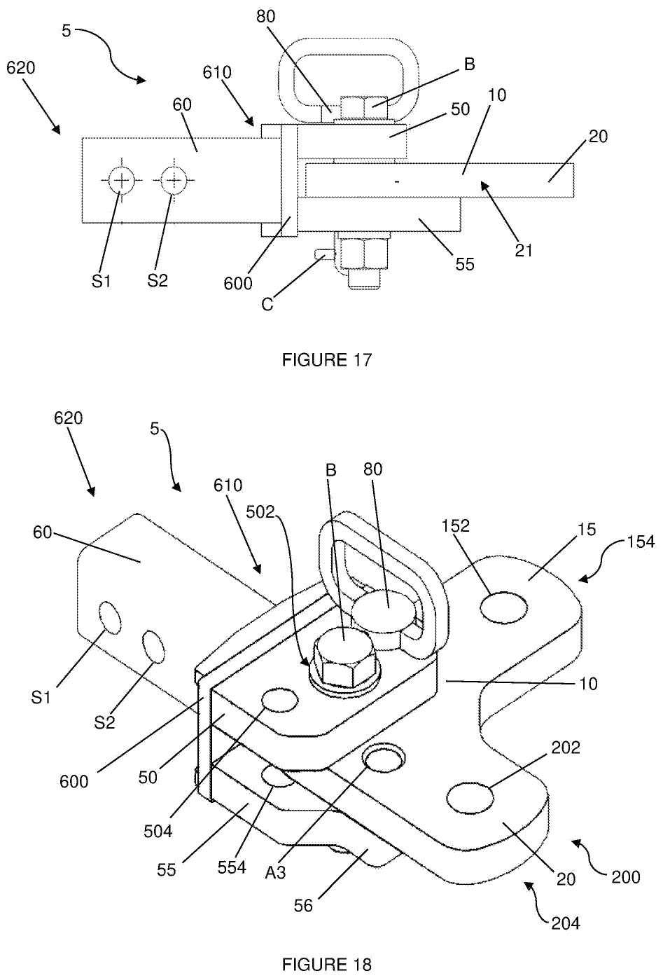

For the embodiment shown, the third part 60 is formed of 50 mm tube pipe, at approximately 10 to 12 mm thick (depending on manufacturing tolerances). As the skilled reader would appreciate, the wall thickness of the tube pipe is preferably of sufficient thickness for structural considerations. In one embodiment, the third part 60 is solid excluding the plurality of apertures S1, S2, S3 used for connecting to the vehicle. As mentioned above, there may be more or less apertures. For example, in the preferred embodiment, there may be two apertures S1, S2 as seen in FIGS. 17 and 18.

To increase or maximise the amount of towing options that can be fitted to the hitching apparatus 5, the apertures 152, 202 formed in the body 10 can be brought closer to their respective adjacent edges (for example, in the order of a few millimeters (depending on manufacturing tolerances), and respective lengths of any of the first 15 and second 20 arm portions can be slightly increased (structural support provided by way of the additional support created by increasing the size of the rearward extending dimension of the second part 55 of the coupling assembly 45). Such configurations can assist in creating additional space to allow for a wider range of towing options connectable/operable with the hitch apparatus 5.

A key feature of the principles of the hitch assembly 5 described herein is that, in use, the body 10 can be selectively rotated from side to side depending on what hitch connector is required for use. By removing the clip C releasably securable at the bottom of the pin 80, and by pulling the pin out, the body 10 is free to rotate. Simple rotation of the body 10 90 degrees about axis X allows the relevant of the apertures (504, 554, and 506, 556) provided with the respective first 50, second 55 parts of the coupling assembly 45 and the relevant of the apertures A2, A3 of the body 10 to concentrically align, thereby enabling the pin 80 to be inserted in the relevantly defined passage to confirm the desired loading position. Thus, the hitching apparatus 5 can be used to provide two separate towing options that are readily available as needed, thereby saving on time and effort in not needing to undo fastener components (eg. nuts) every time hitch connectors are needed to be swapped or switched.

FIG. 7 shows a perspective view of the hitching apparatus 5 carrying a ball type hitch connector 25 by way of the first arm portion 15 (orientated in loading position 150), and carrying a pin type connector 100 by way of the second arm portion 20 (fastened using any appropriate fastener, for example, bolt 102). In the configuration shown, the hitching apparatus 5 is therefore capable of carrying two different types of connecting arrangements so that either can be readily used when needed without undue inconvenience.

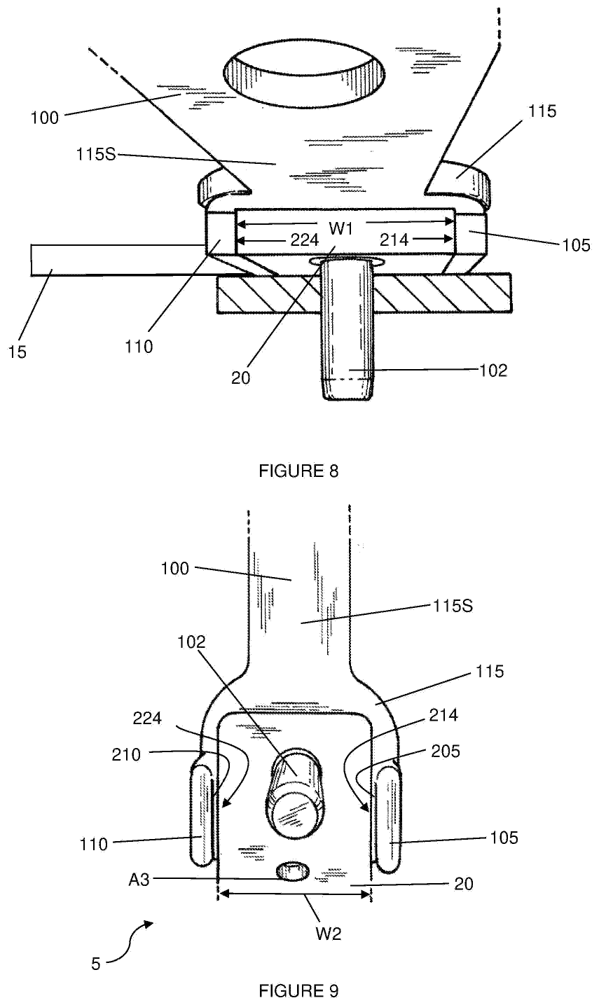

With reference to FIGS. 8 and 9, the body 10 of the hitching apparatus 5 is configured so that one or more portions of the second 20 arm portion is substantially registrable with a portion or region of the physical form of the pin type hitch connector 100 for, at least in part, seeking to stabilise (in, for example, one or more degrees of freedom where relative movement between the registrable components can occur, for example, during a towing operation) the pin type hitch connector 100 in its connection with the second arm portion 20—in addition to fastening of the hitch connector 100 with the second arm portion 20 using bolt 102. Such a physical (or in practice, mechanical) registration seeks to facilitate a ‘snug’ or ‘hugging’ like fit between the relevant arm portion (15, 20) and the pin type hitch connector 100 allowing the portions of both components involved in the registration to cooperate for reducing relative movement or ‘play’ therebetween when in a relevant loading position (150, 200, depending upon which of the arm portions 15, 20 the hitch connector 100 is connected to) during a towing operation.

It will be appreciated that fastening of the hitch connector 100 with the second arm portion 20 using bolt 102 by itself may not secure the hitch connector 100 sufficiently so as to prevent relative movement or ‘play’ creeping in overtime as the bolt 102 becomes subject to extended loading cycles during towing operations. Thus, a form of mutual physical or mechanical registration between the hitch connector 100 and the second arm portion 20 serves as a more ‘fail-safe’ approach to mitigate against any such relative movement or ‘play’ developing and leading to a broader problem.

As seen in FIGS. 8 and 9 (in which the second arm portion 20 is shown by way of example) the second arm portion 20 is configured having substantially parallel spaced apart opposite edges 214, 224 which are dimensioned and shaped so as to fit ‘snugly’ within the space separating spaced apart projections or edge portions 105, 110, each of which extend proud from opposite sides of the underside planar surface 115S of a body 115 of the pin type hitch connector 100. Similar to the second arm portion 20 (as seen in FIGS. 8 and 9), the first arm portion 15 is configured having substantially parallel spaced apart opposite edges which are dimensioned and shaped so as to fit ‘snugly’ within the space separating spaced apart projection or edge portions 105, 110, each which extend proud from opposite sides of the underside planar surface 115S of the body 115 of the pin type hitch connector 100. Each of the spaced apart edge portions 105, 110 are of elongate form (eg. generally of rectangular profile/form providing surfaces of generally planar form) extending finite lengths along respective sides of the body 115 (as shown in both of FIGS. 8 and 9) providing respective surfaces 205, 210 which face toward each other proud of the underside planar surface 115S of the body 115. As will be clear, a dimension W1 (see FIG. 8) between the parallel edges 214, 224 of the second arm portion 20 is sized so as to be commensurate with a dimension W2 (see FIG. 9) between the internal facing surfaces 205, 210 of the spaced apart edge portions 105, 110 of the body 115. In an alternative embodiment, the underside planar surface 115S of the body 115 may comprise a substantially L-shaped projection (not shown) for receiving a corner of the first or second arm portion 15, 20, respectively, so as to reduce or prevent movement of the body 115 relative to the respective first or second arm portion 15, 20.

The dimension W1 between the parallel edges 214, 224 of the second arm portion 20 can be varied so as to control the degree of relative movement or ‘play’ between the second arm portion 20 and the pin type hitch connector 100—this, of course, changes the spacing between the surfaces of the parallel edges 214, 224 of the second arm portion 20 and their respective opposing surfaces 205, 210 of the spaced apart edge portions 105, 110 of the body 115. As will be clear, a tighter tolerance between the parallel edges 214, 224 of the second arm portion 20 and corresponding/respective internal facing surfaces 205, 210 of the spaced apart edge portions 105, 110 operates to reduce relative movement between the second arm portion 20 and the pin type hitch connector 100 thereby influencing the degree of the ‘snugness’ of the mutual fit between both components.

The facing surfaces 205, 210 of respective spaced apart edge portions 105, 110 of the body 115 are of substantially planar form so that they substantially abut corresponding or opposing interfacing surface portions of the parallel edges 214, 224 (also being of substantially planar form) of the second arm portion 20 in a substantially complementary manner, such abutment, along their respective lengths, serving to, in effect, key the hitch connector 100 with the arm portion 20 thereby reducing any ‘play’ that may cause relative movement between the second arm portion 20 and the pin type hitch connector 100. The skilled reader will appreciate that the configuration (eg. shape, position, relative placement) of such surfaces of the of the parallel edges 214, 224 can be varied so as to complement the shape of any portion of a body of any hitch connector for providing a physically registrable engagement (eg. for providing a ‘snug’ or keyed fit) with the second 20 arm portion.

As clearly seen in the Figures, the upper facing surface of each of the first 15, second 20 arm portions is generally planar, which accords with the planar form of the lower facing surface 115S of the body 115 of the pin type hitch connector 100. In this manner, the planar form of both corresponding opposing facing surfaces allows for simple mutual registrability in an abutting manner when the pin type hitch connector 100 is connected with the second arm portion 20. It will be appreciated that the upper facing surfaces of one or both of the first 15, second 20 arm portions could be appropriately configured or formed so as to be complementary with corresponding opposing facing surface portions or regions of bodies of other types of hitch connectors (presenting non-planar forms, for example) for mutual registrability/compatibility purposes.

It will be appreciated that, in the embodiment of the body 10 of the hitching apparatus 5 shown in FIGS. 1 to 6, the first arm portion 15 is also configured or shaped in the manner described above with regard to the second arm portion 20 so that the pin type hitch connector 100 can be registrable therewith, for example, in the event that another type of hitch connector is already fastened with the second arm portion 20 (and vice-versa).

FIGS. 10 to 16 show another embodiment of the hitch apparatus 5 having a number of variations as compared with the embodiment shown in FIGS. 1 to 9. Accordingly, for ease of explanation/description, the same reference nomenclature is retained for analogous/corresponding features. Generally, the embodiment shown in FIGS. 10 to 16 is configured with various differently/conveniently shaped features in order to provide a product that seeks to be more compact, streamlined and versatile.

In the embodiment of the hitch apparatus 5 shown in FIGS. 10 to 16, the pin or bolt B is welded to respective first 50 and second 55 parts of the coupling assembly 45 via the respective apertures 502, 552 through which the pin or bolt B passes.

With particular regard to FIGS. 10 and 15, it can be seen that the respective lengths of the first 15 and second 20 arm portions are different (in contrast to the embodiment shown in FIGS. 1 to 9 in which the respective lengths are equal) with the length of the arm portion 15 being longer than the length of the arm portion 20.

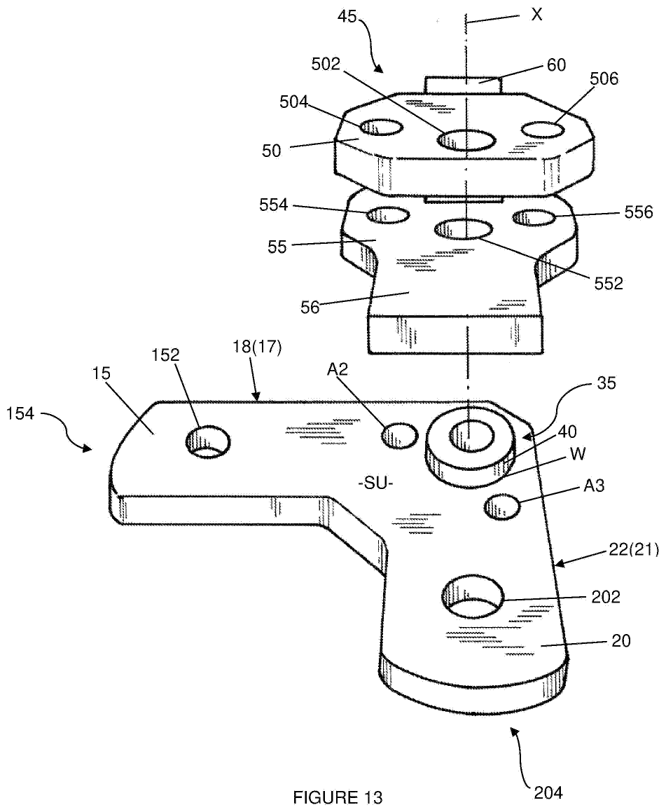

With regard to FIG. 13, it can be seen that the extending portion 56 of the coupling assembly 45 extends further outward than is the case for the analogous part shown in FIGS. 4 and 5. This additional extension in length seeks to confer more support to the body 10 when bearing load during a towing operation.

Furthermore, the embodiment shown in FIGS. 10 to 16 employs a different configuration in respect of the arrangement of the apertures 504, 506 and 554, 556 on respective first 50, second 55 parts of the coupling assembly 45. In this regard, and with reference to FIG. 13, the apertures 504, 506 and 554, 556 are arranged so as to be positioned closer to the axis X than is the case for the embodiment shown in FIG. 4 where the apertures are generally collinear with the first apertures 502, 552 and spaced inward from the edge of the respective part 50, 55. The closer grouping of the apertures 504, 506 and 554, 556 with the axis X shown in FIG. 13 allows the edges of the first part 50 and the second part 55 to be rounded (or chamfered) allowing for a wider range of connector arrangements to be connected with respective first 15, second 20 arm portions so that the connector arrangement may have/enjoy additional clearance (of the first 50, second 55 parts of the coupling assembly 45) when being rotated in/out of its loading position. As the skilled reader would readily appreciate, corresponding apertures A2 and A3 are configured on the body 10 so as to also be grouped closer to the axis X so as to accord with apertures 504, 506 and 554, 556 for ensuring that the desired loading position can be confirmed appropriately via the pin 80 as described above.

FIG. 16 shows that the hitch apparatus 5 can be configured so that the hitch connectors 25 and 100 are not limited to the arm portions shown in FIG. 7, and can be used on different arm portions. FIG. 16 clearly shows that the pin type connector 100 can be carried on the first 15 arm portion, and the ball type hitch connector 25 can be carried by the second 20 arm portion.

Referring to FIGS. 17 and 18 there is a provided an alternative embodiment of the hitching apparatus 5. In an embodiment the coupling assembly 45 comprises the first 50 and second parts 55 arranged and held (by way of a suitable welding process) in spaced relation relative to each other on a coupling member 600. In this embodiment, the third part 60 is coupled to the coupling member 600 at or near the first end 610 of the third part 60. The third part 60 extends away from the coupling member 600 towards a second end 620. The second end 620 of the third part being configured for coupling with the vehicle (for example, within tubular port 61 (shown in FIG. 7) supported by the vehicle's chassis at its rearward end).

With reference to the Figures generally and as mentioned above, the hitching apparatus 5 provides the first 15 and second 20 portions for supporting a respective connector arrangement, such as hitch connectors 25, 100. As described above, the respective first or second portion 15, 20 which is in the loading position 150, 200, respectively may connect to a primary connector arrangement. In an embodiment, the respective portion 15, 20 which is not in the loading position 150, 200, respectively, may be configured and/or suitable for connection of a secondary connector arrangement, such as a bike rack and/or any other compatible adaptation product that may be fitted (not shown).

In one embodiment, the body 10 may be removed from the coupling assembly 45 and flipped or rotated about a longitudinal axis of either of the first, second portions 15, 20. Accordingly, while in some embodiments bolt B may be welded in place to keep the body 10 within the coupling assembly 45. To facilitate the ability to flip the body 10, the bolt B may also removably secure the body 10 to the coupling assembly 45. After flipping or rotating the body 10 about a longitudinal axis of one of the first portion 15 or the second portion 20 the body 10 may be reinserted in the coupling assembly 45. As mentioned above, the first or second portion 15, 20 not in the loading position 150, 200, respectively, may be configured and/or suitable for connection of the secondary connector arrangement thereto. In the example of the secondary connector arrangement being a bike rack, the first or second portion 15, 20 not in the loading position 150, 200 can be effectively flipped or rotated 180 degrees (from a first position to a second position) while keeping the desired first or second portion 15, 20 in the loading position 150, 200. In one embodiment, the body 10 can be rotated about the longitudinal axis extending along the length of the respective first or second portion 15, 20 in the loading position 150, 200, respectively. For example, referring to FIG. 15, body 10 can be separated from the coupling assembly 45 and rotated 180 degrees about a longitudinal axis extending substantially along the first portion 15 parallel to direction D1 until the second portion 20, originally extending towards direction D2, extends towards direction D3 and then reinserted into the coupling assembly 45. This can assist where a bike or other load being towed impedes the ability to see using the rearview mirrors. Furthermore, it may be of assistance in providing room for connecting/disconnecting the vehicle/trailer electrical coupling.

Preferably, the hitching apparatus 5 is sized and legally rated based on the application. For example, a hitching apparatus 5 designed for farming equipment may have a higher rating than for a standard road vehicle. Preferably, the hitching apparatus 5 for use with vehicles is legally rated for at least 3.5 tonne towing capacity.

The various components of the hitching apparatus 5, such as for example, the body 10, are preferably constructed of a rigid and durable material, preferably being solid steel. However, it will be appreciated that other materials may be employed, including composites, ceramics, and the like. Materials having good corrosion resistance are also useful when embodiments of the hitching apparatus 5 are used in hostile environments, for example, in agriculture, chemical processing plants.

Accordingly, in view of the above, the principles upon which the hitching apparatus 5 draws from provides, in one sense, a dual option towing hitch system, comprising of two parts (body 10 and coupling assembly 45), and operable when the body 10 is rotatably coupled with the coupling assembly 45 (and the coupling assembly associated with a vehicle (or prime mover)).

Furthermore, any surface of the various components comprising the hitching apparatus 5 can be used for commercial marketing/promotional purposes. For example, FIG. 6 shows a rear facing vertical surface of the first part 50 of the coupling assembly 45 modified (by way of a laser etching/cutting process, for example) so as to exhibit a website link.

Further aspects of the principles described herein can also be realised in providing related methods of forming or use, hitching systems, and kits of parts for commercial sale.

For example, embodiments of the hitching apparatus 5 may provide a hitching system that comprises any embodiment of the body 10 or coupling assembly 45 drawing from the principles described herein. Methods of forming or operably configuring any of the componentry of the hitching apparatus 5 (eg. the body 10, the coupling assembly 45) consistent with the principles described herein are also contemplated.

Methods for coupling a towable platform to a vehicle using embodiments of a hitching apparatus drawing from the principles described herein are also contemplated.

Broadly, one such implementation comprises providing, forming or operably configuring an embodiment of a body consistent with the body 10 described herein, providing, forming or operably configuring an embodiment of a coupling assembly consistent with the coupling assembly 45 described herein, coupling the body with the coupling assembly, and attaching the coupling assembly with the vehicle or prime mover (or attaching the coupling assembly with the vehicle or prime mover, and then coupling the body with the coupling assembly).

Embodiments of the hitching apparatus 5 or system may be supplied in the form of kits of parts comprising, in a broad form, embodiments of the body 10 as described herein. Such kits may also comprise embodiments of a coupling assembly 45 as described herein (but which could be provided from a supplier separate to that of the body, for example).

It will be appreciated that future patent applications may be filed in Australia or overseas on the basis of, or claiming priority from, the present application.

It is to be understood that the following claims are provided by way of example only and are not intended to limit the scope of what may be claimed in any such future application. Features may be added to or omitted from the provisional claims at a later date so as to further define or redefine the invention or inventions.

1. A hitching apparatus able to receive a ball joint and a pin hitch connector arrangements for providing multiple towing options for use with a vehicle, the hitching apparatus comprising:
a body having first and second arm portions each arranged and configured for supporting at least one respective connector arrangement of the at least ball joint and pin hitch connector arrangements;
the first and second arm portions moveable so as to be selectively positioned to provide a selected one of the arm portions in a loading position for operation with one of the respective ball joint and pin hitch connector arrangements;
a retaining arrangement for retaining the body in the selected one of the arm portions in a loading position for operation with one of the ball joint and pin hitch connector arrangements;
a coupling assembly configured for rotatably coupling the body with the vehicle and the coupling assembly comprising the body having a first aperture formed therein and arranged so as to be substantially concentric with a mounting axis and used to accommodate a shaft or pin portion used in enabling the rotatable movement of the body around the mounting axis while extending normal to the mounting axis;
wherein the coupling assembly includes first and second parts in a spaced arrangement for receiving part of the body therebetween; and
wherein the first and second parts of the coupling assembly are mounted fixedly to a third part of the coupling assembly for fixing the first and second parts in their spaced relationship and, for coupling with the vehicle supported by the vehicle's chassis at its rearward end.

2. A hitching apparatus according to claim 1 wherein the first and second parts of the coupling assembly are mounted on the mounting shaft or pin portion and extend normal to the mounting axis.

3. A hitching apparatus according to claim 1 wherein the body includes first and second arm portions and wherein the first and second parts of the coupling assembly extend normal to the mounting axis to a lesser extent than the body whereby the first and second arm portions of the body extend beyond the first and second parts of the coupling assembly.

4. A hitching apparatus according to claim 1 wherein the coupling assembly allows the first and second arm portions radiating from the mounting axis to be selectively positioned at one of two positions substantially 90° to each other so as to provide a selected one of the loading positions for connection operation with one of the respective ball joint and pin hitch connector arrangements.

5. A hitching apparatus according to claim 1 wherein the first and second arm portions are each arranged and configured by including apertures, shapings and/or edgings in the arm portions of the body beyond the first and second parts of the coupling assembly for supporting at least one respective connector arrangement of the at least ball joint and pin hitch connector arrangements.

6. A hitching apparatus according to claim 1 wherein the coupling assembly includes:
a first set of apertures in the first part and a first set of apertures in the second part wherein at least one of said first set of apertures formed in the first part aligns concentrically with at least one of said first set of apertures formed in the second part; and
a second set of apertures in the first part and a second set of apertures in the second part wherein at least one of said second set of apertures formed in the first part aligns concentrically with at least one of said second set of apertures formed in the second part confirming a loading position of the alternate of the first, second arm portions.

7. A hitching apparatus according to claim 1 wherein the retaining arrangement for retaining the body in the selected one of the arm portions in a loading position for operation with one of the respective connector arrangements includes a pin which can align concentrically with at least one of the first set or second set of apertures formed in the first and second parts of the coupling device and a first or second aperture in the first or second arm portions of the body therebetween.

8. A hitching apparatus for use with a vehicle for providing multiple connector arrangement towing options, the hitching apparatus comprising:
a body configured for providing first and second arm portions arranged for supporting a respective connector arrangement,
each first and second portion movable so as to be selectively positioned so as to provide a selected one of the portions in a loading position for connection with the respective connector arrangement,
wherein one of the first, second arm portions is configured having one or more elements thereof arranged so as to be, at least in part, registrable with one or more sections of the respective connector arrangement on the connection of the one or more sections with the relevant one of the first, second portions for reducing relative movement therebetween
a retaining arrangement for retaining the body in the selected one of the arm portions in a loading position for operation with one of the multiple connector arrangements; and
a coupling assembly configured for rotatably coupling the body with the vehicle and the coupling assembly comprising the body having a first aperture formed therein and arranged so as to be substantially concentric with a mounting axis and used to accommodate a shaft or pin portion used in enabling the rotatable movement of the body around the mounting axis while extending normal to the mounting axis, wherein the coupling assembly includes first and second parts in a spaced arrangement for receiving part of the body therebetween;
wherein the first and second parts of the coupling assembly are mounted fixedly to a third part of the coupling assembly for fixing the first and second parts in their spaced relationship and, for coupling with the vehicle supported by the vehicle's chassis at its rearward end; and
wherein the coupling assembly allows the first and second arm portions radiating from the mounting axis to be selectively positioned at one of two positions substantially 90° to each other so as to provide a selected one of the loading positions for connection operation with one of the multiple connector arrangement towing options.

9. A hitching apparatus according to claim 8, wherein each element comprises a part of an edge of the respective first or second arm portion.

10. A hitching apparatus according to claim 8, wherein each section comprises one or more projections.

11. A hitching apparatus according to claim 8, wherein the first and second arm portions are configurable by rotation of the body about an axis.

12. A hitching apparatus according to claim 8, wherein the body is configurable such that the respective first or second arm portion which is not in the loading position can be moved from a first position to a second position which is opposite the first position.

13. A hitching apparatus according to claim 8, wherein the first or second arm portion is in the loading position when a longitudinal axis of the respective first or second arm portion is substantially aligned or parallel with a longitudinal axis of the vehicle.

14. A hitching apparatus according to claim 8, wherein the first or second arm portion is in the loading position when a longitudinal axis of the respective first or second portion is substantially orthogonal with a longitudinal axis of the vehicle.

15. A hitching apparatus according to claim 8, wherein the body is releasably fixed relative to the coupling assembly by removably inserting a retaining member in a passage defined by alignment of an aperture of the body with one or more apertures of the coupling assembly.

16. A hitching apparatus providing multiple connector arrangement towing options, the hitching apparatus comprising:
a body having:
a first and second arm portions interconnected by a structural web, wherein the arm portions include mounting locations distal to the structural web for receiving a hitch connector and wherein the structural web includes a first aperture adapted to receive a shaft or pin enabling rotational movement of the body about a rotational axis coincidental with the first aperture;
a second and a third aperture on each of the arm portions located proximal to the first aperture;
a coupling assembly for coupling the body to a towing vehicle so that the body is rotatable relative to the vehicle, comprising:
a first and second parts adapted to be held on the towing vehicle in spaced apart relation;
three spaced apart apertures on each of the first and second parts, the three apertures on each of the first and second parts being aligned in a holding condition on the towing vehicle;
wherein the first and second parts of the coupling assembly are held in spaced apart relation by attachment to a third part supported by the vehicles chassis;
wherein in an assembled form, the body is sandwiched between the first and second parts and one aperture in each of the first and second parts is aligned with the first aperture in the structural web, wherein the shaft or pin extends through the aligned apertures in the first and second parts and the structural web to enable rotational movement of the body about the rotational axis relative to the coupling assembly; and
a locating dip adapted to extend through aligned apertures in the coupling assembly and body for releasably locating the body in a select orientation relative to the coupling assembly to selectively locate a select arm portion in a position for connection with a compatible hitch connector on a towed vehicle.

17. The hitching apparatus of claim 16, wherein at least the second part of the coupling assembly is sized to extend further outward than the first part to provide structural to the body when receiving loading from a connected hitch socket.

18. The hitching apparatus of claim 16, wherein the second part of the coupling assembly includes an extending portion which projects outward from the second part to provide additional support for the body when either of the first and second arm and their respective hitch connectors are connected to compatible connectors of equipment to be towed.

19. The hitching apparatus of claim 16, wherein the body further includes a reinforcement portion preferably in the form of a tubular body fixed about and aligned concentrically with the first aperture extending upwardly therefrom.

20. The hitching apparatus of claim 16, wherein lowermost portions of the second and third parts of the coupling assembly are aligned in an assembled condition to substantially minimise drag.
